(19) United States
(12) Patent Application Publication
(10) Pub. No.: US 2007/0036941 A1
(43) Pub. Date: Feb. 15, 2007

(54) Water-soluble salt cores

(75) Inventor: Dieter Groezinger, Wilhermsdorf (DE)

Correspondence Address: PYLE & PIONTEK, 221 N. LASALLE - ROOM 2036, CHICAGO, IL, 60601, US

(73) Assignee: EMIL MULLER GMBH, Wilhermsdorf (DE)

(21) Appl. No.: 10/591,198

(22) PCT Filed: Dec. 11, 2004
(86) PCT No.: PCT/DE04/02718

§ 371 Date: Aug. 30, 2006

(30) Foreign Application Priority Data
Dec. 17, 2003 (DE) 103 59 547.3

(51) Int. Cl. B32B 3/04

(52) U.S. Cl. 428/121

(57) ABSTRACT

The invention relates to water-soluble salt cores which are produced by compacting a mixture of water-soluble salts and a binding agent, under pressure and subsequently subjecting them to heat-treatment. The binding agent is an inorganic phosphate or a mixture of inorganic phosphates having a proportion of between 0.5 and 10 wt. % of the mixture.

The present invention relates to water soluble salt cores having the features of the preamble of claim 1.

Such salt cores for casting purposes that are flushed out of parts after casting as well as attempts at optimizing them by admixing additives have been long known. In DE-C-14 83 641 it has been found that adding up to 10% of borax, magnesium oxide or talcum improves the load capacity of salt cores consisting of NaCI and/or KCI. DE-A-19 34 787 proposes to add a synthetic resin binder and water glass in order to avoid pressing and sintering. These admixtures are also known from U.S. Pat. No. 3,764,575.

The use of synthetic resin binders however is very problematic since they are subject to carbonization and outgassing. This is disadvantageous for casting so that the salt cores are usually pre-heated to a temperature of 600° C. in order for outgassing to occur prior to casting. Since the synthetic resin binders for their main part release stressing gases, a suction means is needed for this process. Another problem arises from the manipulation of the very hot salt cores when placing them into the casting mold. From DE 195 25 307 A1 it is known to manufacture a casting core from perlite, sodium hexametaphosphate and water.

It is the object of the present invention to avoid the problems described by utilizing an alternative binder and to provide salt cores that have already sufficient tensile strength at a sintering temperature of from 200° C., will not be subjected to outgassing at temperatures lower than 700° C. and are adapted to be utilized with all known casting types.

This object is solved with the features recited in claim 1. Advantageous embodiments and developed implementations of the invention and in particular a method of the invention are comprised in the other claims.

In accordance with the invention, water soluble salt cores that are manufactured compacting a mixture of water soluble salts and a binder under pressure and subsequently sintering said compacted mixture are characterized in that the binder is an inorganic phosphate or a mixture of inorganic phosphates with a fraction of between 0.5 and 10 wt. % of the mixture. The mixture can contain a fraction of an inorganic borate. At low compression pressure, a high fraction of binder yields quite rough a surface, whereas at high compression pressure a low fraction of binder yields a smooth surface. At a sintering temperature of 200° C., tensile strengths of between 1 and 3 kg, at 400° C. of between 2 and 3 kg are achieved.

According to an advantageous implementation of the invention, the mixture contains a fraction of between 0 and 10 wt. % of a parting agent such as graphite.

The inorganic phosphate is for example a monoaluminium phosphate, a boron phosphate or a sodium polyphosphate.

Heat treatment is carried out at temperatures of below 730° C., preferably at temperatures ranging between 200° C. and 650° C., so that the aggregate state of the salt cores will not change.

The invention will be illustrated in greater detail herein after by way of example only with reference to tests. Tensile strength was determined by means of a pneumatically operated spring scale with maximum pointer, said maximum pointer indicating a kilogram value when the clamped sample broke.

Test 1

97.5 wt. % of salt with a grain size of 0.16-0.7 mm,
1.5 wt. % of monoaluminium phosphate,
1 wt. % of graphite
   were compacted and thermally treated. The tensile strength obtained were
about 3 kg at 200° C.,
about 3 kg at 300° C.,
about 3 kg at 400° C.,
about 4.5 kg at 500° C.
   Test II
97.5 wt. % of salt with a grain size of 0.16-0.7 mm
1.5 wt. % of boron phosphate
1 wt. % of graphite
   were compacted and thermally treated. The tensile strength obtained were
about 2.4 kg at 200° C.,
about 2.5 kg at 300° C.,
about 2.5 kg at 400° C., about 3-3.5 kg at 500° C.
   Test III
97.5 wt. % of salt with a grain size of 0.16-0.7 mm
1.5 wt. % of sodium polyphosphate
1 wt. % of graphite
   were compacted and thermally treated. The tensile strength obtained were
about 1.3 kg at 200° C.,
about 1.4 kg at 300° C.,
about 2 kg at 400° C.,
about 4 kg at 500° C.
   Test IV
97.5 wt. % of salt with a grain size of 0.16-0.7 mm
1.5 wt. % of boron phosphate with a fraction of an inorganic borate
1 wt. % of graphite
   were compacted and thermally treated. The tensile strength obtained were
about 1.5 kg at 200° C.,
about 1.75 kg at 300° C.,
about 2.5 to 3 kg at 400° C.,
about 3 to 4 kg at 500° C.

With these formulations the cost-expensive pre-heating process in the casting house can be eliminated, the salt cores can be automatically inserted at relatively low temperatures and outgassing will not occur. Also, thermal treatment occurs at temperatures clearly below the sintering temperature (730° C.), which reduces the amount of energy needed to manufacture the cores.

1. Water soluble salt cores manufactured by compacting a mixture of water soluble salts and binder under pressure and by subsequently subjecting said compacted mixture to a thermal treatment, characterized in that the binder is an inorganic phosphate or a mixture of inorganic phosphates with a fraction of between 0.5 and 10 wt. % of said mixture.

2. The water soluble salt cores as set forth in claim 1, characterized in that the binder contains a fraction of an inorganic borate.

3. The water soluble cores as set forth in claim 1 characterized in that the mixture contains a fraction of between >0 and 10 wt. % of a parting agent.

4. The water soluble salt cores as set forth in claim 1, characterized in that the inorganic phosphate is a monoaluminium phosphate.

5. The water soluble salt cores as set forth in claim 1, characterized in that the inorganic phosphate is a boron phosphate.

6. The water soluble salt cores as set forth in claim 1, characterized in that the inorganic phosphate is a sodium polyphosphate.

7. The water soluble salt cores as set forth in claim 1 characterized in that thermal treatment occurs at temperatures of less than 730° C.
